(19) United States
(12) Patent Application Publication
(10) Pub. No.: US 2014/0002357 A1
(43) Pub. Date: Jan. 2, 2014

(54) Enabling and Disabling Features of a Headset Computer Based on Real-Time Image Analysis

(71) Applicant: KOPIN CORPORATION, Taunton, MA (US)

(72) Inventors: Stephen A. Pombo, Campbell, CA (US); Jeffrey J. Jacobsen, Hollister, CA (US); Christopher Parkinson, Richland, WA (US)

(73) Assignee: KOPIN CORPORATION, Taunton, MA (US)

(21) Appl. No.: 13/837,048

(22) Filed: Mar. 15, 2013

Related U.S. Application Data
(60) Provisional application No. 61/665,400, filed on Jun. 28, 2012.

(51) Int. Cl. G06F 3/01

(52) U.S. Cl. CPC G06F 3/012
USPC 345/158

(57) ABSTRACT

Operating conditions for a headset computer are determined using input from a speed sensor or accelerometer together with the results of scene analysis performed on images captured by a camera embedded in the headset computer. If the headset is travelling above a predetermined speed, and if the scene analysis returns a decision that the wearer is sitting in a driver's seat of the vehicle, then one or more features of the headset computer are disabled or restricted. The headset computer may disable display operation, mobile phone operation, or change audio interface options, or take other actions.

### RELATED APPLICATION(S)

This application claims the benefit of U.S. Provisional Application No. 61/665,400, filed on Jun. 28, 2012, the entire teachings of which are incorporated herein by reference.

### BACKGROUND

Mobile computing devices, such as notebook personal computers (PC's), Smartphones, and tablet computing devices, are now common tools used for producing, analyzing, communicating, and consuming data in both business and personal life. Consumers continue to embrace a mobile digital lifestyle as the ease of access to digital information increases with high-speed wireless communications technologies becoming ubiquitous. Popular uses of mobile computing devices include displaying large amounts of high-resolution computer graphics information and video content, often wirelessly streamed to the device. While these devices typically include a display screen, the preferred visual experience of a high-resolution, large format display cannot be easily replicated in such mobile devices because the physical size of such devices is limited to promote mobility. Another drawback of the aforementioned device types is that the user interface is hands-dependent, typically requiring a user to enter data or make selections using a keyboard (physical or virtual) or touch-screen display. As a result, consumers are now seeking a hands-free high-quality, portable, color display solution to augment or replace their hands-dependent mobile devices.

### SUMMARY

The present disclosure relates to human/computer interfaces and more particularly to a headset computer that determines when a user may be wearing the headset computer while in a potentially unsafe situation, such as when operating a vehicle. If the potentially unsafe condition is detected, one or more operational features of the headset computer are disabled.

Recently developed micro-displays can provide large-format, high-resolution color pictures and streaming video in a very small form factor. One application for such displays can include integration into a wireless headset computer worn on the head of the user with the display positioned within the field of view of the user, similar in format to eyeglasses, an audio headset, or video eyewear. A “wireless computing headset” device includes one or more small high-resolution micro-displays and optics to magnify the image. The WVGA micro-displays can provide super video graphics array (SVGA) (800×600) resolution or extended graphic arrays (XGA) (1024×768) or even higher resolutions. A wireless computing headset contains one or more wireless computing and communication interfaces, enabling data and streaming video capability, and provides greater convenience and mobility than hands dependent devices.

For more information concerning such devices, see co-pending U.S. application Ser. No. 12/348,646 entitled “Mobile Wireless Display Software Platform for Controlling Other Systems and Devices,” by Parkinson et al., filed Jan. 5, 2009, PCT International Application No. PCT/US09/38601 entitled “Handheld Wireless Display Devices Having High Resolution Display Suitable For Use as a Mobile Internet Device,” by Jacobsen et al., filed Mar. 27, 2009, and U.S. Application No. 61/638,419 entitled “Improved Headset Computer,” by Jacobsen et al., filed Apr. 25, 2012, each of which are incorporated herein by reference in their entirety.

A headset computer (HSC) may also be referred to as a headset computing device or headmounted device (HMD) herein. A headset computer can be equipped with a camera and other sensors, such as speed or acceleration sensor. An image can be captured with the camera. The captured image can be processed using image processing techniques to perform feature extraction. Feature extraction can be performed locally at the headset computer (e.g., by the HSC processor) or remotely by a networked processor, for example in the cloud. The combination of the detected image features and the current speed and/or acceleration information can be used to determine if the current environment is safe for operating the headset computer. The operation of the headset computer functions or features can be modified based on results of the safety determination. If an unsafe condition is detected, the operations, functions and/or features controlled can include powering down the HSC to an “off” state, or operating the HSC in an “audio-only” mode, in which the display is disabled and turned off. If an unsafe condition is not detected, the HSC can operate unrestricted.

In an example embodiment, operating conditions for a headset computer are determined using input from a speed sensor or accelerometer together with the results of scene analysis (e.g., image processing with feature extraction) performed on images captured by the camera integrated with the headset computer. If the HSC is travelling above a predetermined speed or acceleration threshold, and if the scene analysis returns a decision that the wearer is apparently sitting in the driver's seat of a motor vehicle, then one or more operating features or functions of the headset computer can be disabled or restricted. For example the display can be disabled or the mobile phone operation can be restricted, audio interface options can be changed, or other actions can be controlled.

The scene analysis may detect the presence of a steering wheel, manufacturers' logos, handlebars, gauges, levers, or other elements indicative of what an operator of a vehicle typically sees while operating the vehicle.

Further, the scene analysis may account for a typical view from the perspective of a passenger of a vehicle, when determining whether the user of the headset computer is driving.

Generally, in accordance with principles of the present invention, the HSC can automatically turn off its display or control other features when the user wearing the HSC is attempting to operate or operating a moving vehicle. Thus, driver/user is protected against the temptation to use the HSC while driving and, thereby, causing a potentially dangerous situation. At the same time, a passenger can continue to use a fully functional HSC while travelling in a vehicle.

Example embodiments using both (i) speed and/or acceleration data and (ii) scene analysis results provide additional fidelity that is useful compared to using either in isolation.

An example method of controlling operation of a headset computer, according to principles of the present invention, includes determining whether an acceleration or a velocity of the headset computer is greater than a predetermined threshold, capturing an image from a perspective of a user of the headset computer using a camera of the headset computer, comparing the captured image against one or more template images representative of elements of a vehicle as seen by occupants of the vehicle, and disabling one or more features of the headset computer based on the comparison of the captured image and the template images indicating that the user of the headset computer is operating a vehicle.

For example, the one or more features disabled can include operation of a micro-display or a 3G/4G cellular radio.

Example methods of controlling operation of a headset computer can further including enabling one or more features of the headset computer based on the comparison of the captured image and the template images indicating that the user of the headset computer is not operating a vehicle.

Further, the one or more features enabled can include operation of the headset computer in an audio only mode or operation of the headset computer wireless communications in a Bluetooth only mode.

The one or more of the one or more template images can be stored in a local memory of the headset computer or in a non-local memory accessible to the HSC.

An example method can further include determining a current global positioning location of the headset computer and associated jurisdiction based of the current location, and updating the one or more template images to reflect a right-hand drive or left-hand vehicle based on the determined jurisdiction.

The elements compared can include any one of the following: a steering wheel, manufacturer logos, speedometer, tachometer, fuel level gauge, battery gauge, oil pressure gauge, temperature gauge, stick shift, heating/air conditioning vents, a windshield orientation relative to a side window(s), car doors, and navigation systems.

According to principles of the present invention, a headset computer having a micro-display, audio components, camera, motion sensor, data storage media, and programmable data processor including one or more data processing machines that execute instructions retrieved from the data storage media, the instructions can be for: (i) determining whether an acceleration or a velocity received from the motion sensor is greater than a predetermined threshold, (ii) capturing image data using the camera, (iii) processing the image data to extract one or more image features, (iv) combining the image features and velocity and/or acceleration information to determine if a current environment is safe for operating at least one function of the headset computer, and (v) selectively enabling or disabling the headset computer function depending on the result of determining if the current environment is safe.

The example embodiments, for a determination that the current environment is not safe, the micro-display can be disabled, an audio-only function can be enabled, a 3G/4G cellular radio function can be disabled, and a Bluetooth wireless communications function can be enabled. For a determination that the current environment is determined to be safe, the HSC functions can be fully enabled.

Example embodiments can further include accessing one or more image features from a network-based storage media in the determination if the current environment is safe.

Another example embodiment can further include a Global Positioning System (GPS) receiver to determine a current location and based on the current location determine jurisdiction associated therewith, and further combine a right-hand drive or left-hand drive determination based on the jurisdiction to determine if the current environment is safe or update an image template.

The extracted one or more image features can represent any one of the following: a steering wheel, manufacturer logos, speedometer, tachometer, fuel level gauge, battery gauge, oil pressure gauge, temperature gauge, stick shift, heating/air conditioning vents, a windshield orientation relative to a side windows, car doors, and navigation systems.

Still further example embodiment includes a non-transitory computer program product for controlling operation of a headset computer, the computer program product comprising a computer readable medium having computer readable instructions stored thereon, which, when loaded and executed by a processor, cause the processor to determine whether an acceleration or a velocity of the headset computer is greater than a predetermined threshold, capture an image from a perspective of a user of the headset computer, compare the captured image against one or more template images representative of elements of a vehicle as seen by occupants of the vehicle, and disable or enable one or more features of the headset computer based on the comparison of the captured image and the template images indicating that the user of the headset computer is operating a vehicle.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is a perspective view of an example embodiment of a headset computer in which the approaches described herein may be implemented.

FIG. 1B illustrates and example embodiment of a headset computer wirelessly communicating with a host computing device (e.g., Smartphone, PC. etc.) and employing a user interface responsive to voice commands, head motions, and hand movements.

FIG. 2 is a high-level electronic system block diagram of the components of the headset computer.

FIGS. 3A and 3B are example scenes including image features taken from inside an automobile from the perspective of the driver and passenger, respectively.

FIG. 4 is an example scene including image features from the perspective of a motorcycle operator.

FIG. 5 is an example scene including image features from an operator of an antique tractor.

FIG. 6 is a flow diagram of a process executed by a processor in the headset to control operation based on speed and scene information.

### DETAILED DESCRIPTION OF EXAMPLE EMBODIMENTS

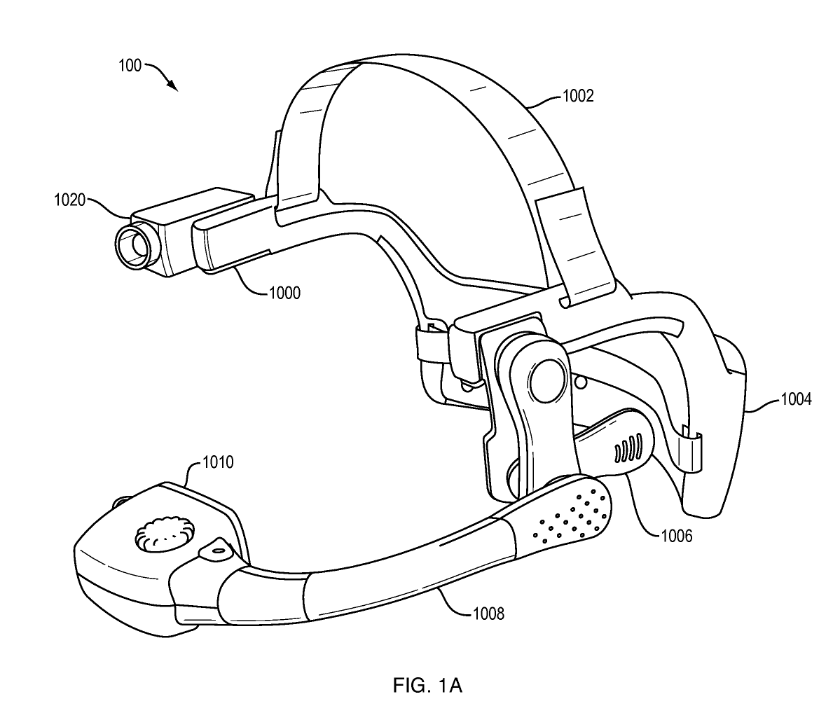

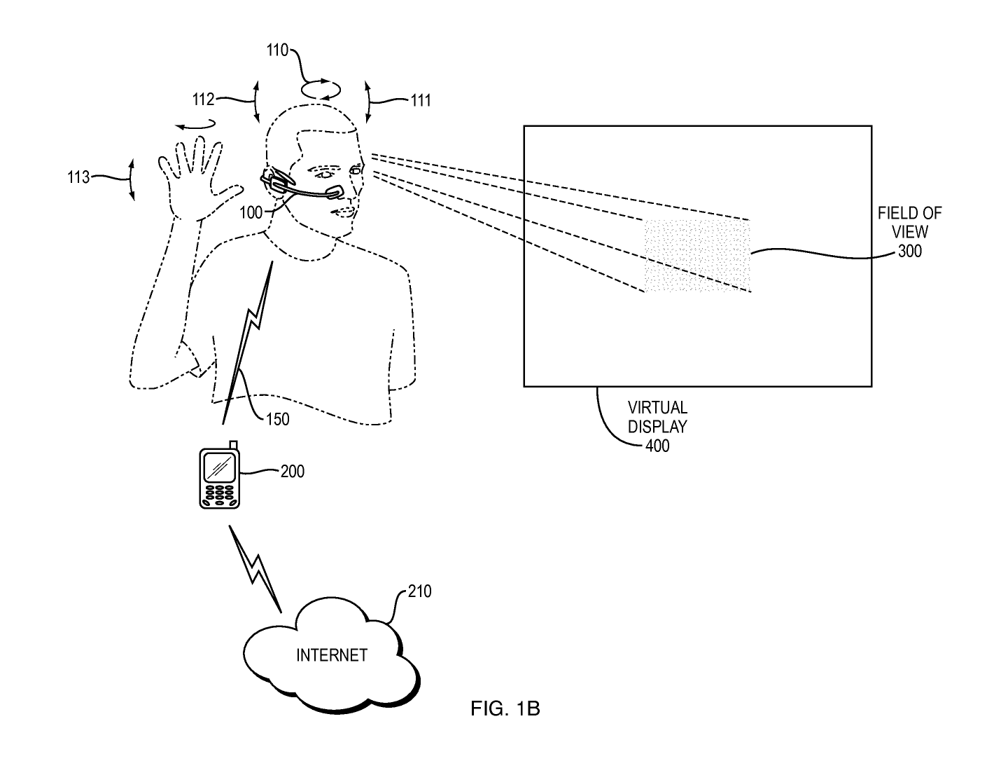

FIGS. 1A and 1B show an example embodiment of a wireless hands-free computing headset device 100 (also referred to herein as a headset computing device, headset computer (HSC) or headmounted device (HMD)) that incorporates a high-resolution (VGA or better) micro-display element 1010, and other features described below.

FIG. 1A depicts a HSC 100 and generally includes a frame 1000, strap 1002, housing section 1004, speaker(s) 1006, cantilever or arm 1008, micro display 1010, and camera 1020. Also, located within the housing 1004 are various electronic circuits including, as will be understood shortly, a microcomputer (single or multi-core processor), one or more wired or wireless interfaces, and/or optical interfaces, associated memory and/or storage devices, and various sensors.

A head worn frame 1000 and strap 1002 are generally configured so that a user can wear the headset computer device 100 on the user's head. A housing 1004 is generally a low profile unit which houses the electronics, such as the microprocessor, memory or other storage device, low power wireless communications device(s), along with other associated circuitry. Speakers 1006 provide audio output to the user so that the user can hear information, such as the audio portion of a multimedia presentation, or audio prompt, alert, or feedback signaling recognition of a user command.

Micro-display subassembly 1010 is used to render visual information, such as images and video, to the user. Micro-display 1010 is coupled to the arm 1008. The arm 1008 generally provides physical support such that the micro-display subassembly is able to be positioned within the user's field of view, preferably in front of the eye of the user or within its peripheral vision preferably slightly below or above the eye. Arm 1008 also provides the electrical or optical connections between the micro-display subassembly 1010 and the control circuitry housed within housing unit 1004.

The electronic circuits located within the housing 1004 can include display drivers for the microdisplay element 1010 and input and/or output devices, such as one or more microphone(s), speaker(s), geo-position sensors, 3 axis to 9 axis degrees of freedom orientation sensing, atmospheric sensors, health condition sensors, GPS, digital compass, pressure sensors, environmental sensors, energy sensors, acceleration, position, altitude, motion, velocity or optical sensors, cameras (visible light, infrared (IR), ultra violet (UV), etc.), additional wireless radios (Bluetooth®, Wi-Fi®, LTE, 3G Cellular, 4G Cellular, NFC, FM, etc.), auxiliary lighting, range finders, or the like, and/or an array of sensors embedded in the headset frame and/or attached via one or more peripheral ports. (Bluetooth is a registered trademark of Bluetooth Sig, Inc., of Kirkland Washington; and Wi-Fi is a registered trademark of Wi-Fi Alliance Corporation of Austin Tex.)

As illustrated in FIG. 1B, example embodiments of the HSC 100 can receive user input through recognizing voice commands, sensing head movements, 110, 111, 112 and hand gestures 113, or any combination thereof. Microphone(s) operatively coupled or preferably integrated into the HSC 100 can be used to capture speech commands which are then digitized and processed using automatic speech recognition (ASR) techniques. Speech can be a primary input interface to the HSC 100, which is capable of detecting a user's voice, and using speech recognition, derive commands. The HSC 100 then uses the commands derived from the speech recognition to perform various functions.

Gyroscopes, accelerometers, and other micro-electromechanical system sensors can be integrated into the HSC 100 and used to track the user's head movement to provide user input commands. Cameras or other motion tracking sensors can be used to monitor a user's hand gestures for user input commands. The camera(s), motion sensor(s) and/or positional sensor(s) are used to track the motion and/or position of the user's head, hands and/or body in at least a first axis 111 (horizontal), but preferably also a second (vertical) 112, third (depth) 113, fourth (pitch) 114, fifth (roll) 115 and sixth (yaw) 116. A three axis magnetometer (digital compass) can be added to provide the wireless computing headset or peripheral device with a full 9 axis degrees of freedom position accuracy. The voice command automatic speech recognition and head motion tracking features of such a user interface overcomes the hands-dependant formats of other mobile devices.

The headset computing device 100 can wirelessly communicate with a remote host computing device 200. Such communication can include streaming video signals received from host 200, such that the HSC 100 can be used as a remote auxiliary display. The host 200 may be, for example, a notebook PC, Smartphone, tablet device, or other computing device having sufficient computational complexity to communicate with the HSC 100. The host may be further capable of connecting to other networks 210, such as the Internet. The HSC 100 and host 200 can wirelessly communicate via one or more wireless protocols, such as Bluetooth®, Wi-Fi®, WiMAX or other wireless radio link 150.

The HSC 100 can be used as a stand alone, fully functional wireless Internet-connected computer system.

The HSC 100 with microdisplay 1010 can enable the user to select a field of view 300 within a much larger area defined by a virtual display 400. The user can control the position, extent (e.g., X-Y or 3D range), and/or magnification of the field of view 300.

The HSC may be embodied in various physical forms such as a monocular head mounted computer as shown, but also as a wearable computer, digital eyewear, electronic eyeglasses, and in other forms.

In one embodiment the HSC may take the form of the HSC described in a co-pending U.S. patent application Ser. No. 13/018,999, entitled “Wireless Hands-Free Computing Headset With Detachable Accessories Controllable By Motion, Body Gesture And/Or Vocal Commands” by Jacobsen et al., filed Feb. 1, 2011, which is hereby incorporated by reference in its entirety.

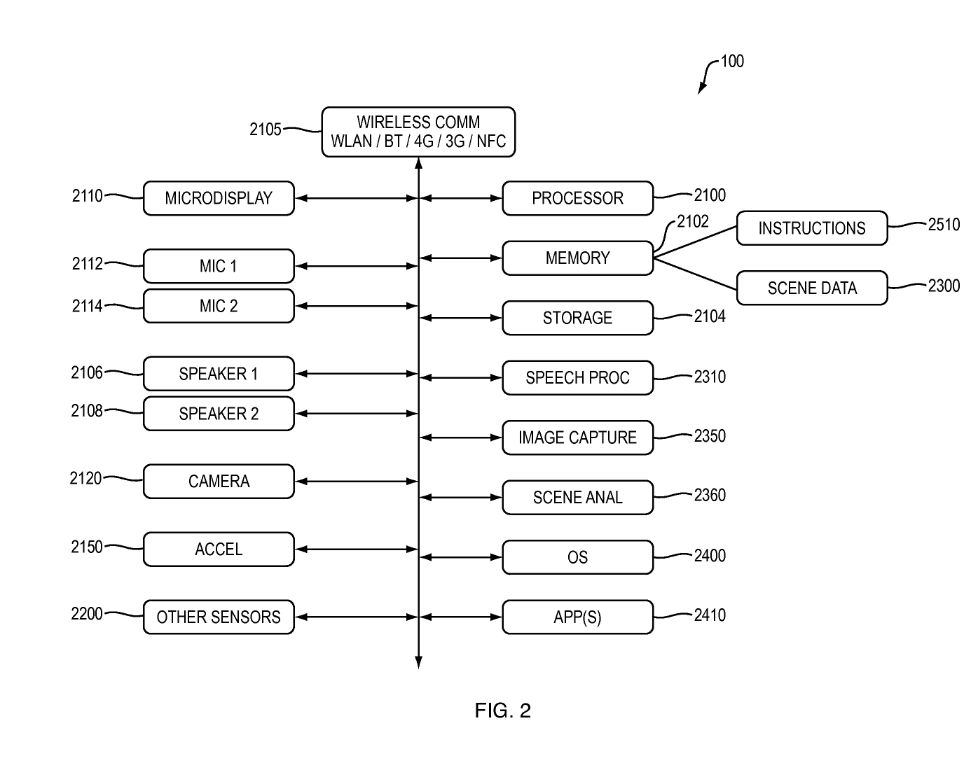

FIG. 2 is a high-level block diagram of the electronic system of the headset computer 100. The electronics system includes a processor 2100, memory 2102, and mass storage 2104, as is typical for any programmable digital computer system. Also included in the electronics system are the microdisplay 2110, one or more microphones 2112, 2114, speakers 2106, 2108, wireless communication module(s) 2105, camera 2120, and accelerometer 2150 or other speed sensors 2200, such as a Global Position System (GPS) receiver that can deliver speed and/or acceleration information.

In order to determine whether to restrict or inhibit certain features of the HSC 100 due to an unsafe environment, such as the operation of a vehicle by the HSC 100 user, the processor 2100 executes instructions 2105 that are stored in the memory 2102 and accesses data stored in the memory 2102 and/or storage 2104. The processor 2100 may for example execute instructions 2105 embodied as software code. The processor 2100 may also make use of an operating system 2400 and applications 2410 running within the context of the operating system 2400 to provide various functions.

In an example embodiment, the processor 2100 can execute stored instructions 2105 to perform image capture 2350 and perform scene analysis 2360. The instructions to perform image capture 2360 may include calls for the camera 2120 to first activate autofocusing, autobalancing and/or other image capturing features, then take a picture. Performing scene analysis 2360 can determine whether or not the image data contains some specific object, feature, element or activity. Scene analysis 2360 can be performed in any variety of ways, including, for example object or feature recognition, identification, or detection, and can include content-based image retrieval. The image capture 2350 and scene analysis 2360 preferably occur in real time, and, therefore, are preferably implemented as low-level system calls, or even kernal-level functions in the operating system 2400. But in some instances image capture 2350 and scene analysis 2360 may also be implemented as applications 2410 running on top of the operating system 2400.

The memory 2102 and or storage not only store instructions 2105 for the processor to carry out, but can also store one more scene data templates 2300. Scene data templates 2300 are digital representations of images typically seen by the operator and/or occupants of a motor vehicle.

More particularly, the processor 2100 is programmed to automatically use the embedded camera 2120 and accelerometer 2150 to determine when a vehicle operator is wearing the headset computer 100. When the HSC 100 determines that such a condition exists, one or more features of the HSC 100 are then disabled. However, even when the accelerometer 2150 (or GPS 2200, etc.) indicates the vehicle is moving above the predetermined speed, if the scene analysis 2360 concludes that the user of the headset computer is not operating the vehicle, but rather is a passenger in the vehicle, the HSC may remain fully functional. The combination of speed or acceleration sensor 2150, 2200, and scene analysis 2360 provides a useful safety feature for drivers while providing a pleasant experience for passengers. Passengers are able to fully use and enjoy the HSC 100 while traveling in a motor vehicle, while the automatic shut off safety feature prevent the driver of the vehicle from using the HSC 100 completely, or at least enabling only certain features known to be safe for the situation. In such a diminished operating mode, the HSC 100 may enable only the audio functions, and/or other functions, such as just the Bluetooth connectivity function. Thus, the driver may still be able to use the Bluetooth audio system built into the vehicle to make calls using the 3G/4G cellular radios in the HSC 100 or stream other audio content.

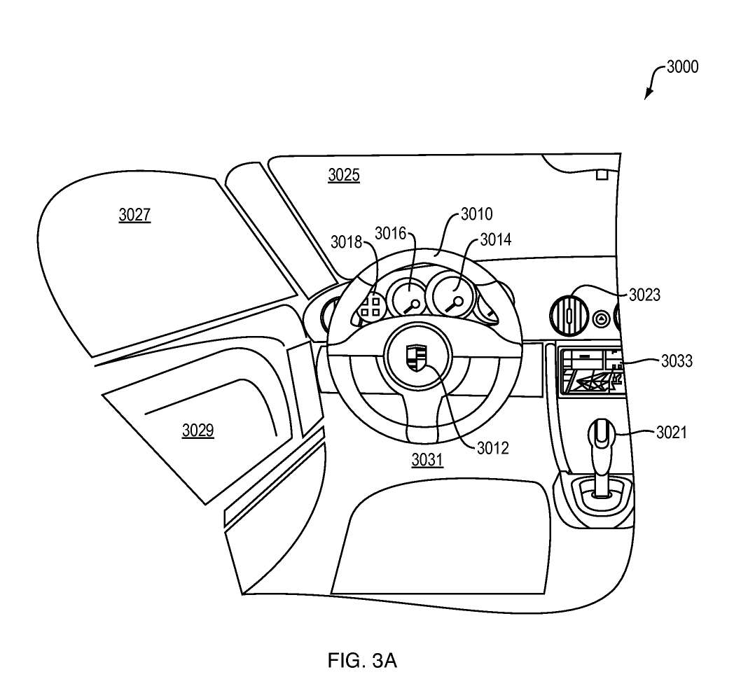

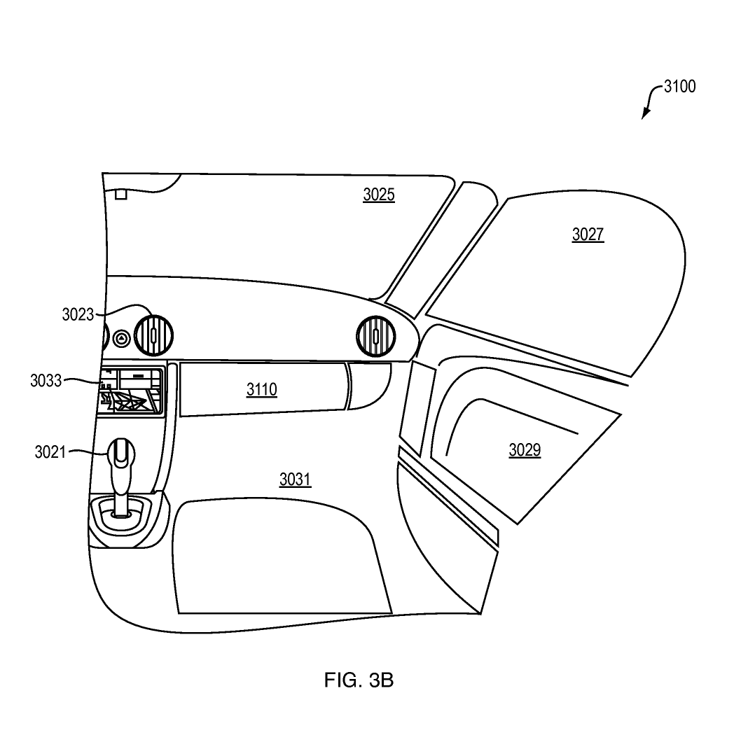

FIGS. 3A and 3B illustrate image data representing typical scene data 2300 that can be stored in the HSC 100 and representative of an image captured by camera 2120.

FIG. 3A is a scene 3000 of the components inside a vehicle taken from the perspective of a driver. The primarily recognizable component element or image feature of the scene 3000 is a steering wheel 3010. But other elements or image features of the scene 3000 can be useful in scene analysis 2360 and can include manufacturer logos 3012 (in the center of the steering wheel 3010), speedometer 3014, tachometer 3016, fuel level 3018 and other gauges, operator controls, such as a stick shift 3021, heating/air conditioning vents 3023, the relative orientation of the windshield 3025 and side windows 3027, the presence of car doors 3029, floors 3031, other instruments located to the side of the dashboard, such as navigation systems 3033. Image features that specify the relative orientation of doors 3029, windshields 3025, and side windows 3027 for both left-hand and right-hand drive automobiles can be included in image templates and scene data 2300.

Stored scene data 2300 or template images can include data for both right-hand and left-hand drive vehicles. Further, such stored scene data 2300 can include jurisdictional data. The jurisdictional data can include the geographical locations of jurisdictions and whether it is a left-hand drive or right-hand drive jurisdiction. For example, a HSC 100 with GPS can provide location information, which can then be used to determine the jurisdiction in which the HSC 100 is located. Such jurisdictional information can be used to prioritize scene analysis for left-hand drive or right-hand drive vehicles. For example, if the GPS determines the HSC 100 is located in Canada, then scene analysis for a right-hand drive vehicle can be prioritized.

The stored scene elements 2300 can also account the possible zoom settings of the camera 2120. For example, on some zoom settings only a portion of the dashboard may be visible (such as only a portion of the wheel 3010 and a few gauges 3018), whereas on other zoom settings, the windshield 3025, side windows 3027, doors 3029 and even portions of the floor 3031 may be visible. Such various possibilities can be accounted for by storing the scene data in particularly efficient ways, for example, by storing multiple versions of a given scene for different zoom levels or by using hierarchical scene element models.

Stored scene data 2300 may also include representations of vehicle occupant scenes such as scene 3100 of FIG. 3B, which is typical of what is viewed by a passenger in the front seat. While some elements remain the same (such as the presence of a navigation system 3033 and stick shift 3025), here they are located on the opposite side of the view or scene 3100 compared to the driver scene 3000 of FIG. 3A. Most prominently, however, the scene 3100 is missing the steering wheel 3010 and gauges 3018, and includes the presence of other indicative items, such as a glovebox 3110.

Any convenient known scene analysis (image recognition) algorithm may be used by scene analysis 2360 to compare the images obtained by image capture 2350 against the scene data templates 2300. Such algorithms preferably can be relatively high-speed since the user's access to the device or device features is being controlled. The algorithms are preferably carried out in real time, and, therefore, can be embodied as high priority operating system calls, interrupts, or even embedded in the operating system kernal, depending on the processor type and operating system selected for implementation.

In an alternative example embodiment, the processor 2100 can execute stored instructions 2105 to perform image capture 2350 and upload the scene data to a host 200 for cloud-based scene analysis and receive a scene analysis decision. By utilizing cloud-based resources, a cloud-based scene analysis can perform a more computationally intense scene analysis than the scene analysis 2360 that is performed on-board (i.e., locally) the HSC 100. Cloud-based scene analysis can have access to a vast library of vehicle scene that may be impractical to store at the local memory 2102 due to resource limitations. Cloud-based scene analysis, in coordination with an appropriate scene analysis (image recognition) algorithm—a design decision that enables sufficiently quick processing and decision making—can also be used to limit the user's access to operational features of the HSC 100. Such cloud-based analysis can be useful to unburden and off-load some of the memory intense and computationally intense processes from the HSC 100.

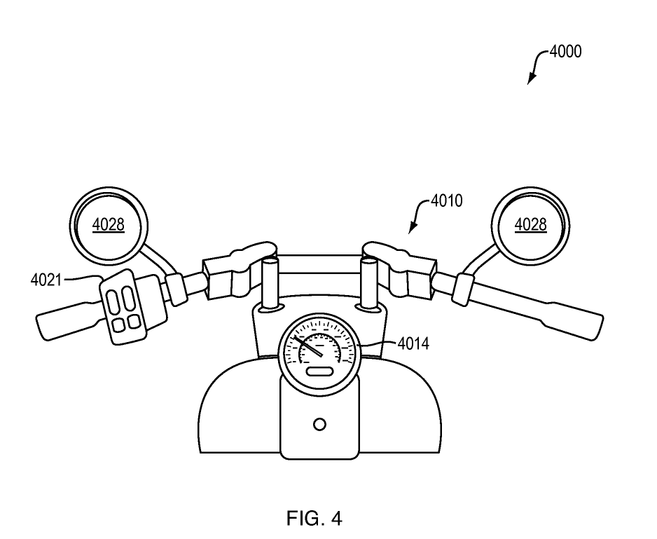

FIG. 4 is a scene 4000 typical of the operator of a motorcycle. Here, elements such as handlebars 4100, gas tanks and gauges 4014, mirrors 4028, and shifter 4021 can be included in the scene data templates 2300.

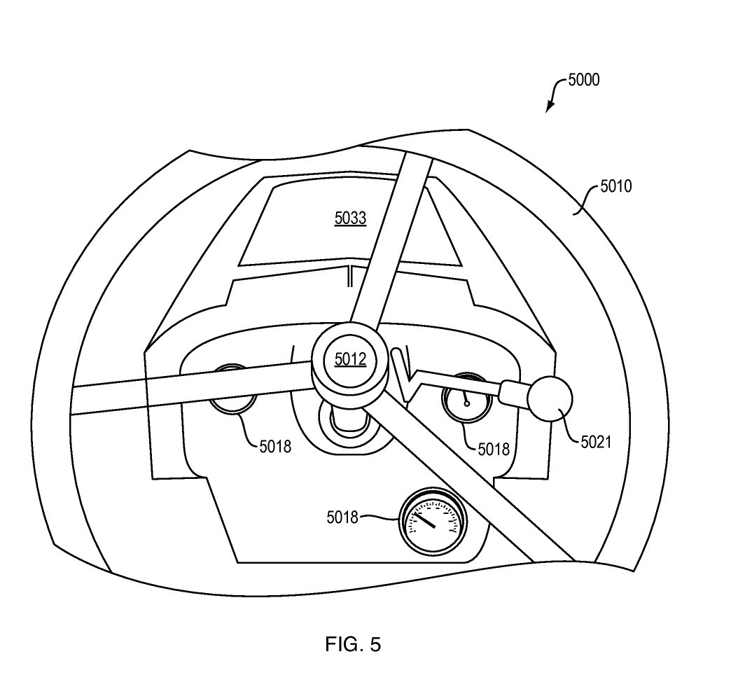

FIG. 5 is a scene 5000 from the perspective of an operator of an antique tractor. In scene 5000, the operator may be sitting very close to a very large steering wheel 5010 and, therefore, only a few portions of the steering wheel 5010 are visible. Other elements may include gauge(s) 5018, levers 5021 and hood section 5033 of the tractor that can be extracted as image features for recognition of scene 5000.

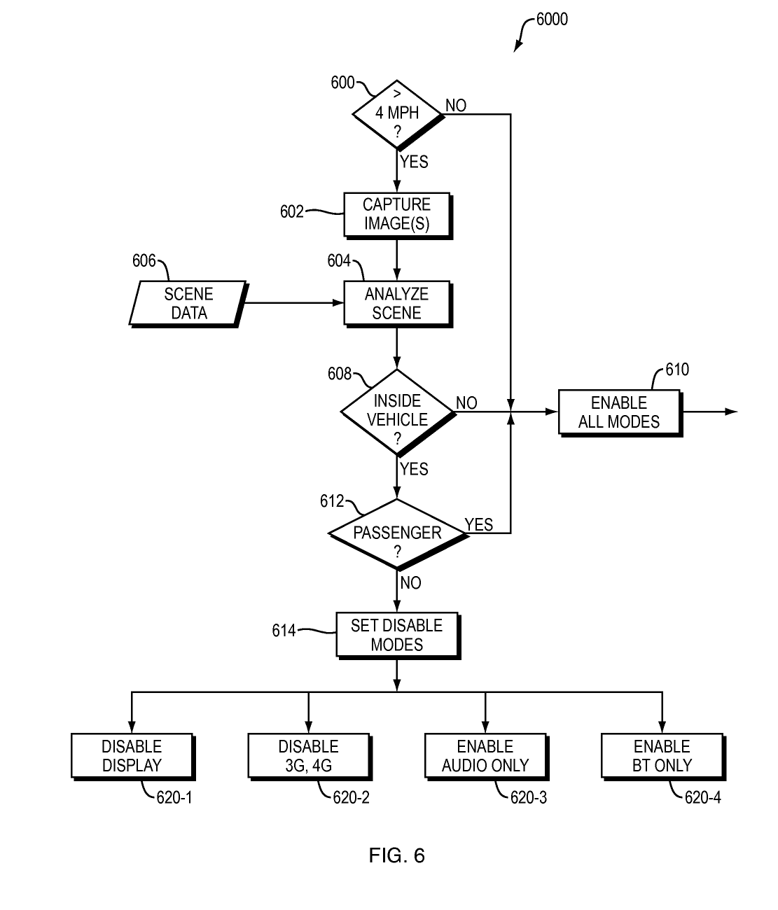

FIG. 6 is a flow diagram of a process 6000 that can be executed by the processor 2100 to implement control over the HSC 100 using the speed sensor 2150 and scene analysis 2360. In a first stage 600, a speed and/or acceleration is determined an compared to a threshold. For example, the accelerometer 2150 or GPS 2200 may indicate rapid acceleration or constant speed above a certain amount, such as 4 miles per hour (MPH).

If the speed and/or acceleration are low (i.e, less than the threshold), then the processing moves forward to stage 610, where all features, modes and functions of the headset computer 100 may be enabled.

However, if the acceleration or speed is above the predetermined amount (i.e., greater than the threshold), then stage 602 is entered. At stage 602 one or more images are captured using the camera 2120. The images captured in stage 602 are then processed by scene analysis 2360 in stage 604. A scene analysis stage 604 may make use of various scene data templates 606, accessed via either the memory 2102 or storage 2104. The scene data templates 606 (or 2300) can be representative of scenes typically viewed by the operators and passengers of motor vehicles, such as those described above with respect to scenes 3000, 3100, 4000, 5000.

Stage 608 may make a determination as to whether or not the user of the HSC 100 is travelling in (or on) a vehicle. If this is not the case, then stage 610 can be entered, where all available operating modes are active.

If the scene analysis of stage 608 concludes that the operator is inside a vehicle, then stage 612 is entered. At stage 612, a determination is made as to whether or not the user is a passenger in (or on) the vehicle. If the user is determined to be an occupant, then processing can continue to stage 610 where all operating modes are enabled.

However, if the wearer is determined to be a driver, then stage 614 is entered. At stage 614, one or more modes of operational features or functions of the HSC 100 are enable or disabled. As one example, stage 620-1 can disable the display. Stage 620-2 can disable the wireless communication interfaces such as 3G or 4G cellular. Stage 620-3 can enable only audio functions, such as the microphones and speakers. In stage 620-4, the display, speaker, and microphones are enabled with only a Bluetooth interface and cellular voice functions are enabled. The Bluetooth (BT) mode 620-4 can permit the driver to place a voice telephone call using an external, in-vehicle, safe, Bluetooth system.

Other variations are possible. For example, there may be a way for the user of the HSC 100 to override the driver-detection feature 6000, such as by providing certain specialized commands via the voice recognition functions.

Although the example embodiment described herein are limited to ground vehicles, those having skill in the art should recognize that embodiments of disclosed invention can be applied in other environments and in other contexts to ensure safe usage of the HSC 100.

It should be understood that the example embodiments described above may be implemented in many different ways. In some instances, the various “data processors” described herein may each be implemented by a physical or virtual general purpose computer having a central processor, memory, disk or other mass storage, communication interface(s), input/output (I/O) device(s), and other peripherals. The general purpose computer is transformed into the processors and executes the processes described above, for example, by loading software instructions into the processor, and then causing execution of the instructions to carry out the functions described.

As is known in the art, such a computer may contain a system bus, where a bus is a set of hardware lines used for data transfer among the components of a computer or processing system. The bus or busses are essentially shared conduit(s) that connect different elements of the computer system (e.g., processor, disk storage, memory, input/output ports, network ports, etc.) that enables the transfer of information between the elements. One or more central processor units are attached to the system bus and provide for the execution of computer instructions. Also attached to system bus are typically I/O device interfaces for connecting various input and output devices (e.g., keyboard, mouse, displays, printers, speakers, etc.) to the computer. Network interface(s) allow the computer to connect to various other devices attached to a network. Memory provides volatile storage for computer software instructions and data used to implement an embodiment. Disk or other mass storage provides non-volatile storage for computer software instructions and data used to implement, for example, the various procedures described herein.

Embodiments may therefore typically be implemented in hardware, firmware, software, or any combination thereof.

In certain embodiments, the procedures, devices, and processes described herein are a computer program product, including a computer readable medium (e.g., a removable storage medium such as one or more DVD-ROM's, CD-ROM's, diskettes, tapes, etc.) that provides at least a portion of the software instructions for the system. Such a computer program product can be installed by any suitable software installation procedure, as is well known in the art. In another embodiment, at least a portion of the software instructions may also be downloaded over a cable, communication and/or wireless connection.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read only memory (ROM); random access memory (RAM); storage including magnetic disk storage media; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

It also should be understood that the block and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and thus the computer systems described herein are intended for purposes of illustration only and not as a limitation of the embodiments.

Therefore, while this invention has been particularly shown and described with references to example embodiments thereof, it will be understood by those skilled in the art that various changes in form and details may be made therein without departing from the scope of the invention encompassed by the appended claims.

What is claimed is:

1. A method of controlling operation of a headset computer comprising:
determining whether an acceleration or a velocity of a headset computer is greater than a predetermined threshold;
through a camera of the headset computer, capturing an image from a perspective of a user of the headset computer;
comparing the captured image against one or more template images representative of elements of a vehicle as seen by occupants of the vehicle; and
disabling one or more features of the headset computer based on the comparison of the captured image and the template images indicating that the user of the headset computer is operating a vehicle.

2. The method of controlling operation of a headset computer of claim 1, wherein the one or more features disabled includes operation of a micro-display.

3. The method of controlling operation of a headset computer of claim 1, wherein the one or more features disabled includes operation of a 3G/4G cellular radio.

4. The method of controlling operation of a headset computer of claim 1, further including enabling one or more features of the headset computer based on the comparison of the captured image and the template images indicating that the user of the headset computer is not operating a vehicle.

5. The method of controlling operation of a headset computer of claim 4, wherein the one or more features enabled includes operation of the headset computer in an audio only mode.

6. The method of controlling operation of a headset computer of claim 4, wherein the one or more features enabled includes operation of the headset computer wireless communications in a Bluetooth only mode.

7. The method of controlling operation of a headset computer of claim 1, wherein one or more of the one or more template images are not stored in a local memory of the headset computer.

8. The method of controlling operation of a headset computer of claim 1, further including:
determining a current global positioning location of the headset computer and associated jurisdiction based thereon; and
updating the one or more template images to reflect right-hand drive or left-hand vehicles based on the determined jurisdiction.

9. The method of controlling operation of a headset computer of claim 1, wherein the elements compared includes any one of the following: a steering wheel, manufacturer logos, speedometer, tachometer, fuel level gauge, battery gauge, oil pressure gauge, temperature gauge, stick shift, heating/air conditioning vents, a windshield orientation relative to a side windows, car doors, and navigation systems.

10. A headset computer comprising:
a micro-display;
audio components;
a camera;
a motion sensor;
a data storage media;
a programmable data processor comprising one or more data processing machines that execute instructions retrieved from the data storage media, the instructions for:
determining whether an acceleration or a velocity received from the motion sensor is greater than a predetermined threshold;
capturing image data using the camera;
processing the image data to extract one or more image features;
combining the image features and velocity and/or acceleration information to determine if a current environment is safe for operating at least one function of the headset computer; and
selectively enabling or disabling the headset computer function depending on the result of determining if the current environment is safe.

11. The apparatus of claim 10, wherein the current environment is determined to not be safe, and the micro-display is disabled.

12. The apparatus of claim 10, wherein the current environment is determined to not be safe, and an audio-only function is enabled.

13. The apparatus of claim 10, wherein the current environment is determined to be safe, and the headset computer function is fully enabled.

14. The apparatus of claim 10, wherein the wherein the current environment is determined to not be safe, and a 3G/4G cellular radio function is disabled.

15. The apparatus of claim 10, wherein the wherein the current environment is determined to not be safe, and a Bluetooth wireless communications function is enabled.

16. The apparatus of claim 10, further including accessing one or more image features from a network-based storage media in the determination if the current environment is safe.

17. The apparatus of claim 10, further including a Global Positioning System (GPS) receiver to determine a current location and jurisdiction associated therewith, and further combing a right-hand drive or left-hand drive determination based on the jurisdiction to determine if the current environment is safe.

18. The apparatus of claim 10, wherein the extracted one or more image features represents any one of the following: a steering wheel, manufacturer logos, speedometer, tachometer, fuel level gauge, battery gauge, oil pressure gauge, temperature gauge, stick shift, heating/air conditioning vents, a windshield orientation relative to a side windows, car doors, and navigation systems.

19. A non-transitory computer program product for controlling operation of a headset computer, the computer program product comprising a computer readable medium having computer readable instructions stored thereon, which, when loaded and executed by a processor, cause the processor to:
determine whether an acceleration or a velocity of a headset computer is greater than a predetermined threshold;
capture an image from a perspective of a user of the headset computer;
compare the captured image against one or more template images representative of elements of a vehicle as seen by occupants of the vehicle; and
disable or enable one or more features of the headset computer based on the comparison of the captured image and the template images indicating that the user of the headset computer is operating a vehicle.
